(19) United States
(12) Patent Application Publication
(10) Pub. No.: US 2021/0336262 A1
(43) Pub. Date: Oct. 28, 2021

(54) POSITIVE ELECTRODE ACTIVE MATERIAL AND ITS PREPARATION METHOD, SODIUM ION BATTERY AND APPARATUS CONTAINING THE SODIUM ION BATTERY

(71) Applicant: Contemporary Amperex Technology Co., Limited, Ningde City (CN)

(72) Inventors: Qian LIU, Ningde City (CN); Wenguang Lin, Ningde City (CN); Chengdu Liang, Ningde City (CN); Yongsheng Guo, Ningde City (CN)

(73) Assignee: Contemporary Amperex Technology Co., Limited, Ningde City (CN)

(21) Appl. No.: 17/371,207

(22) Filed: Jul. 9, 2021

Related U.S. Application Data
(63) Continuation of application No. PCT/CN2020/070137, filed on Jan. 2, 2020.

(30) Foreign Application Priority Data
Jan. 11, 2019 (CN) 201910026508.1

(51) Int. Cl. H01M 4/525; H01M 10/054; H01M 4/505

(52) U.S. Cl. CPC H01M 4/525; H01M 2004/021; H01M 4/505; H01M 10/054

(57) ABSTRACT

The present application discloses a positive electrode active material and its preparation method, a sodium ion battery and an apparatus containing the sodium ion battery. The positive electrode active material satisfies a chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m≤0.1, h+k+l+m=1, 0≤y≤0.2, and the positive electrode active material has a water content of 6000 ppm or less.

### CROSS-REFERENCE OF RELEVANT APPLICATION

This application is a continuation of International Application No. PCT/CN2020/070137, filed on Jan. 2, 2020, which claims priority of Chinese patent application No. 201910026508.1 filed on Jan. 11, 2019, both of which are incorporated herein by reference in their entireties.

### TECHNICAL FIELD

This application belongs to the technical field of energy storage apparatuses, and specifically involves a positive electrode active material and its preparation method, a sodium ion battery, and an apparatus containing the sodium ion battery.

### BACKGROUND TECHNOLOGY

At present, a lithium-ion battery dominates the power battery. Nevertheless, the lithium-ion battery is facing a great challenge, such as the increasing shortage of lithium resources, the continuous increase of upstream material price, the sluggish development of recycling technology, and a low recycling rate of old and used batteries. Sodium ion batteries can realize charging and discharging by a sodium ion intercalation-deintercalation process between positive and negative electrodes. Moreover, compared with lithium, sodium has the advantages of much richer reserves, wider distribution, and lower cost. Therefore, the sodium ion battery is likely to become a new generation of electrochemical system to replace the lithium-ion battery. However, positive active materials for a sodium ion battery under extensive research at present have relatively poor actual capacity and cycle performance, which hinders the commercialization progress of sodium ion battery.

### SUMMARY

In a first aspect, this application provides a positive electrode active material that satisfies the chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m<0.1, h+k+l+m=1, 0≤y<0.2 and wherein the positive electrode active material has a water content of 6000 ppm or less.

In a second aspect, this application provides a method for preparing a positive electrode active material, including the following steps:

providing a mixed solution, wherein the mixed solution comprises copper salts, iron salts and manganese salts, and the salts containing an M element in the mixed solution have a content of ≥0;

adding a precipitant and a complexing agent into the mixed solution, and then subjecting to coprecipitation to obtain a precursor; and

mixing the precursor and a sodium source to obtain a mixture and sintering the mixture to obtain the positive electrode active material,

wherein the positive electrode active material satisfies the chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0<k≤0.32, 0<l≤0.68, 0≤m<0.1, h+k+l+m=1, 0≤y<0.2, and the positive electrode active material has a water content of 6000 ppm or less.

In a third aspect, this application provides a sodium ion battery comprising a positive electrode plate containing the positive electrode active material in the first aspect of this application.

In the fourth aspect, this application provides an apparatus comprising the sodium ion battery in the third aspect of this application.

Compared with the existing technologies, this application at least has the following beneficial effects.

The positive electrode active material provided in this application satisfies the chemical formula of Na₁₋ₓCuₕFeₖMnₗMₘO_{2-y} and the positive electrode active material has a specific chemical composition and water content, which enable the positive electrode active material to have relatively high ionic and electronic conductivity, and which is also beneficial to reduce the interface side reaction of the positive electrode active material, thereby improving charging/discharging capacity elaboration and cycle performance of the positive electrode active material.

In addition, since the positive electrode active material of the present application has the above-mentioned specific chemical composition and water content, it effectively inhibits the formation of sodium hydroxide layer without electrochemical activity due to irreversible chemical reactions on the surface of particles, and reduces the loss of reversible sodium ions, thereby improving the capacity retention rate of the positive electrode active material. At the same time, the positive electrode active material is stable to air and carbon dioxide, which effectively inhibits the formation of sodium carbonate layer without electrochemical activity due to irreversible chemical reactions on the surface of particles, and reduces the loss of reversible sodium ions, thereby further improving the capacity retention rate of the positive electrode active material.

Since the formation of sodium hydroxide and sodium carbonate layers on the surface of the positive electrode active material particles is effectively inhibited, the hindrance to the diffusion of sodium ions and electrons is prevented, the reaction between a positive electrode active material, a binder and an electrolyte is reduced, and the corrosion effect of the positive electrode active material on the positive electrode current collector is effectively inhibited, thereby improving the electrochemical performance and safety performance of the positive electrode.

Therefore, the positive electrode active material of the present application can have a higher charging/discharging capacity performance, cycle performance, and safety performance. The sodium ion battery adopting the positive electrode active material can thus obtain a higher charging/discharging capacity elaboration, cycle performance and safety performance. The apparatus of this application includes the sodium ion battery provides in this application so that it at least has the same advantages as the said sodium ion battery.

### DESCRIPTION OF THE DRAWINGS

In order to explain the technical solutions of the embodiments of the present application more clearly, the following will briefly introduce the drawings that need to be bused in the embodiments of the present application. Obviously, the drawings described below are only some embodiments of the present application. A person of ordinary skill in the art can obtain other drawings based on the drawings without creative work.

FIG. 1 is a schematic diagram of an embodiment of a sodium ion battery.

FIG. 2 is an exploded view of FIG. 1.

FIG. 3 is a schematic diagram of an embodiment of battery module.

FIG. 4 is a schematic diagram of an embodiment of battery pack.

FIG. 5 is an exploded view of FIG. 4.

FIG. 6 is a schematic diagram of an embodiment of an apparatus using the sodium ion battery as a power source.

### DETAILED DESCRIPTION

In order to make the objectives, technical solutions and beneficial technical effects of the present application clearer, the present application will be further described in detail below in conjunction with embodiments. It should be understood that the embodiments described in this specification are only for explaining the application, not intending to limit the application.

For the sake of brevity, only certain numerical ranges are explicitly disclosed herein. However, any lower limit may be combined with any upper limit to form a range that is not explicitly described; and any lower limit may be combined with other lower limits to form an unspecified range, and any upper limit may be combined with any other upper limit to form an unspecified range. Further, although not explicitly specified, each point or single value between the endpoints of the range is included in the range. Thus, each point or single value can be combined with any other point or single value as its own lower limit or upper limit or combined with other lower limit or upper limit to form a range that is not explicitly specified.

In the description herein, it should be noted that, unless otherwise specified, a numeric range described with the term “above” or “below” includes the lower or upper limit itself, and “more” in “one or more” means two or more.

The above summary of the present application is not intended to describe each disclosed embodiment or every implementation in this application. The following description illustrates exemplary embodiments more specifically. In many places throughout the application, guidance is provided through a series of examples, which can be used in various combinations. In each instance, the enumeration is only a representative group and should not be interpreted as exhaustive.

### Positive Electrode Active Material

Firstly, the positive electrode active material in the first aspect of this application is described. This positive electrode active material satisfies the chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m≤0.1, h+k+l+m=1, 0≤y<0.2, and the positive electrode active material has a water content of 6000 ppm or less. Herein, 1 ppm (1 part per million) means that 1 gram of water contained in 1,000,000 grams of positive electrode active material.

The positive electrode active material provided by the present application having the above-mentioned specific chemical composition and water content, enables the ion and electron migration in the inner side of the positive electrode active material to be less hindered, so that the positive electrode active material has relatively high ion conductivity and electron conductivity, and the positive electrode active material is beneficial to reduce the side reaction at the interface of the positive electrode active material. Thus, the charging/discharging capacity elaboration and cycle performance of the positive electrode active material are further improved. More optionally, the positive electrode active material also has higher dynamic performance and rate performance.

In addition, since the positive electrode active material of the present application has the above-mentioned specific chemical composition and water content, it effectively inhibits the formation of sodium hydroxide layer without electrochemical activity due to irreversible chemical reactions on the surface of particles, and reduces the loss of reversible sodium ions, thereby improving the capacity retention rate of the positive electrode active material. At the same time, the positive electrode active material is stable to air and carbon dioxide, which effectively inhibits the formation of sodium carbonate layer without electrochemical activity due to irreversible chemical reactions on the surface of particles, and reduces the loss of reversible sodium ions, thereby further improving the capacity retention rate of the positive electrode active material.

Since the formation of a sodium hydroxide layer on the surface of the particles is effectively inhibited, a bimolecular elimination reaction of hydroxide ions as a basic group with CF and CH bonds of the binder is prevented, and the increase of brittleness of the positive electrode plate is inhibited due to the formation of carbon-carbon double bonds, which can greatly reduce the probability of the positive electrode plate being broken, improve mechanical performance of the positive electrode plate, and further improve the working stability and safety performance of batteries. In addition, since the increase of carbon-carbon double bonds in the binder is inhibited, the viscosity of the slurry is prevented from increasing due to addition of a binder with excessively high viscosity and the slurry is avoided from gelling, so that the quality of the slurry is improved, and the quality of the positive electrode plate and the consistency of the preparation process are improved.

Since the formation of a sodium hydroxide layer on the surface of the particles is effectively inhibited, the reaction of sodium hydroxide with electrolyte salts in the electrolyte is also prevented, and the consumption of sodium ions in the electrolyte is reduced, thereby improving the capacity retention rate of batteries. In addition, the amount of hydrogen fluoride gas as produced is reduced, thereby avoiding the damage of the solid electrolyte interface (SEI) membrane caused by hydrogen fluoride, further reducing the consumption of electrolyte and sodium ions, and further increasing the battery capacity retention rate and improving cycle performance. Since the generation of hydrogen fluoride gas is reduced, the corrosion to the internal metal parts of batteries caused by acidic hydrogen fluoride is also reduced, thereby improving the structural stability and safety performance of batteries.

Since the formation of a sodium carbonate layer on the surface of the particles is effectively inhibited, the decomposition of sodium carbonate to produce carbon dioxide gas during the battery charging process is prevented, which is beneficial to maintain a low pressure inside batteries, and further prevent the deformation of the battery core due to increased internal stress and the phenomenon such as swelling and leakage, therefore the battery maintains high electrochemical performance and safety performance.

Since the formation of sodium hydroxide and sodium carbonate layers on the surface of the positive electrode active material particles is effectively inhibited, the hindrance to the diffusion of sodium ions and electrons is prevented, and the corrosion effect of the positive electrode active material on the positive electrode current collector is effectively inhibited, so that the positive electrode behave with a good electrochemical performance and the positive electrode plate maintains a good mechanical stability, thereby ensuring that the battery has a good charging/discharging performance and safety performance.

Therefore, the positive electrode active material of the present application can have a higher charging/discharging capacity performance, cycle performance, and safety performance. The sodium ion battery adopting the positive electrode active material can thus obtain a higher charging/discharging capacity elaboration, cycle performance and safety performance.

Further, the water content of the positive electrode active material of the present application is from 10 ppm to 6000 ppm. Furthermore, the water content of the positive electrode active material of the present application is from 50 ppm to 2000 ppm.

In some embodiments, optionally, the positive electrode active material of the present application satisfies 0<m<0.1. By doping the M element at the transitional metal site of the positive electrode active material, the charging/discharging capacity elaboration and cycle performance of the positive electrode active material can be further improved. Optionally, M may be one or more selected from Li, B, Mg, Al, Ti, Co, Ni, Zn, Ga, Sr, Mo,

In, Sn and Ba. More optionally, M may be one or more selected from Li, B, Mg, Al, Ti, Co, Ni, Zn, and Ba. Particularly optionally, M may be one or more selected from B, Mg, Al and Ti.

In some embodiments, the specific surface area of the positive electrode active material is preferable to be from 0.01 m²/g to 25 m²/g, more preferable to be from 0.5 m²/g to 15 m²/g, such as from 0.5 m²/g to 5 m²/g. The specific surface area of the positive electrode active material is within an appropriate range, which can improve the stability of the positive electrode active material to air, water and carbon dioxide, and reduce the side reaction activity of the electrolyte on the surface of the positive electrode active material, thereby better producing the above effects and improving the charging/discharging capacity elaboration, cycle performance and safety performance of the positive electrode.

In some embodiments, the average particle size Dᵥ50 of the positive electrode active material is preferable to be from 0.5 μm to 30 μm, more preferable to be from 1 μm to 15 μm, and particularly preferable to be from 4 μm to 10 μm. The particle size of the positive electrode active material is optionally 30 μm or less, which enables the diffusion and transmission path between sodium ions and electrons to be relatively short, and the positive electrode active material to have improved ionic and electronic conductivity, thereby improving the electrochemical dynamic performance and rate performance during its charging/discharging process. This positive electrode active material also reduces the positive polarization phenomenon, which enables the batteries to have higher specific capacity, coulomb efficiency and cycle performance. In addition, the particle size of the positive electrode active material is optionally 0.5 μm or more, so that the area of the positive electrode active material in contact with the environment during production, storage and use is appropriately reduced, the reaction activity between the particles and the water and carbon dioxide in the environment can be reduced and the side reaction between the particles and the electrolyte is reduced so as to conducive to the preparation process of the slurry and the electrode plate, thereby enabling the battery using it to have higher electrochemical performance and safety performance. The particle size of the positive electrode active material is optionally 0.5 μm or more, which can also effectively inhibit the agglomeration between the positive electrode active material particles in the positive electrode active material layer and ensure that the battery has higher rate performance and cycle performance.

In some embodiments, the powder resistivity of the positive electrode active material at a pressure of 12 MPa is preferable to be from 10 Ω·cm to 90 kΩ·cm, more preferable, from 20 Ω·cm to 5 kΩ·cm. The positive electrode active material having a powder resistivity within a proper range can further improve the rate performance of sodium ion battery and safety performance.

In some embodiments, the tap density of the positive electrode active material is optionally from 1 g/cm³ to 3.5 g/cm³, more optionally from 1.5 g/cm³ to 3.0 g/cm³.

In some embodiments, the compaction density of the positive electrode active material under a pressure of 8 tons is optionally from 2.5 g/cm³ to 5.0 g/cm³, more optionally from 3.5 g/cm³ to 4.5 g/cm³. The compaction density of the positive electrode active material within an appropriate range is beneficial to increase the specific capacity and energy density of the battery, and improve the rate performance and cycle performance of batteries.

In some embodiments, the shape of the positive electrode active material is preferable to be one or more of sphere, globoid, and polygon flake. Spherical and globoid positive electrode active materials are secondary particles composed of primary particle by aggregation, and the shape of primary particle can be sphere, globoid, or flake. The positive electrode active material with a polygon-flake structure can be one or more of triangular flake, tetragonal flake, and hexagonal flake. The positive electrode active material can have a more stable structure during the charging/discharging cycle so that the sodium ion battery can have a better cycle performance.

In some embodiments, the positive electrode active material has a hexagonal layered crystal structure. This positive electrode active material with such a crystal structure has a better structural stability, and its structural change caused by the process of de-intercalation and intercalation of sodium ions is relatively small, and its stability in air and water is better, thereby further improving the cycle performance of the positive active materials.

In some embodiments, the positive electrode active material comprises a characteristic diffraction peak of (003) crystal plane and a characteristic diffraction peak of (104) crystal plane, and the characteristic diffraction peak of (003) crystal plane has a full width at half maxima of from 0.01° to 0.5°, and the characteristic diffraction peak of (104) crystal plane has a full width at half maxima of from 0.01° to 0.5°. The characteristic diffraction peak of crystal plane (003) has a diffraction angle 2θ in the range of 15.9° to 16.2° ; and the characteristic diffraction peak of crystal plane (104) has a diffraction angle 20 in the range of 41.5° to 41.7°.

The positive electrode active material with the said crystal structure has a relatively good crystallinity degree, which is conducive to further improving the capacity elaboration and cycle performance of positive electrode active material.

The crystal structure and characteristic diffraction peak of positive electrode active material can be measured by an X-ray powder diffractometer. For example, with Brucker D8A_A25 X-ray diffractometer of Brucker AxS, Cukα ray is regarded as a radiation source, the ray wavelength λ=1.5418°, the scanning 2θ angle range is from 10° to 90°, and the scanning rate is 4°/min.

The specific surface area of positive electrode active material is of the meaning known in this field and can be measured by the known instruments and methods in this field. For example, it can be tested by the analysis test method of nitrogen adsorption specific surface area and calculated by BET (Brunauer Emmett Teller) method in which the analysis test method of nitrogen absorption specific surface area can be carried out by the Tri StarII specific surface and pore analyzer from Micromeritics, USA.

The average particle size of positive electrode active material Dᵥ50 is of the meaning known in this field and can be measured by the instruments and methods known in this field. For example, it can be conveniently measured by a laser particle size analyzer, such as the Mastersizer 3000 laser particle size analyzer of Malvern Instrument, UK.

The water content of the positive electrode active material can be measured using instruments and methods known in the art. As an example, the positive electrode active material is dried in a vacuum oven, and the mass of the dried positive electrode active material is weighed and denoted as q1. The above operation is usually carried out in a drying room. Then the positive electrode active material is put into a penicillin bottle for sealing, and the Karl Fischer moisture meter is used to measure the water content of the positive electrode active material, recorded as p1 in which the temperature of the instrument is elevated to 170° C. Finally, the water content p of the positive electrode active material is calculated according to p=p1/q1.

The shape of positive electrode active material can be measured by the instruments and methods known in this field. For example, it can be detected by a field emission scanning electron microscope, such as SIGMA 500 high-resolution field emission scanning electron microscope of Karl Zeiss AG, Germany.

The tap density of positive electrode active material can be measured by the instruments and methods known in this field. For example, it can be measured conveniently by a tap density tester, such as the FZS4-4B tap density tester.

The compaction density of positive electrode active material can be measured by the instruments and methods known in this field. For example, it can be measured conveniently by an electron pressure tester, such as the UTM7305 electron pressure tester.

In the following, the preparation method of the positive electrode active material provided in the second aspect of this application will be introduced. According to this preparation method, the said positive electrode active material can be obtained. The preparation method of the positive electrode active material provided by the present application includes the following steps:

S10. adding a copper salt, an iron salt, a manganese salt, and an optional salt containing M element to a solvent in a stoichiometric ratio to prepare a mixed solution;

S20. adding a precipitant and a complexing agent to the mixed solution to obtain a reaction solution, and adjusting a pH value of the reaction solution to a preset range;

S30. subjecting the reaction solution to coprecipitation reaction at a preset temperature and stirring speed, separating and collecting the resulting coprecipitation products, washing the precipitation products several times with an appropriate amount of solvent, and drying them at a preset temperature to get a transitional metal source [CuₕFeₖMnₗMₘ]Xᵤ, wherein X is a negative ion taken from the precipitant, and h, k, l, m, and u allow the chemical formula [CuₕFeₖMnₗMₘ]Xᵤ to be electrical neutral;

S40. mixing the transitional metal source and sodium source to obtain a mixture and sintering the mixture, and washing and drying the resulting sintering product to obtain the positive electrode active material.

As different reactants have different dissociation intensities in a solvent and a same reactant has different dissociation intensities in different solvents, the reaction rate is affected, including crystal nucleation and growth rate, further the chemical composition, specific surface area, particle size, shape, and crystal structure of the transitional metal source are affected, and finally the chemical composition, specific surface area, particle size, shape, and crystal structure of the positive electrode active material are affected.

In some preferred embodiments, in the step S10, the copper salt may include one or more of copper nitrate, copper chloride, copper sulfate, copper acetate and copper oxalate, optionally, one or more of copper nitrate and copper sulfate. The iron salt may include one or more of ferric nitrate, ferrous nitrate, ferric chloride, ferrous chloride, ferric sulfate, ferrous sulfate, ferric acetate, ferrous acetate, ferric oxalate, and ferrous oxalate, optionally one or more of ferric nitrate, ferrous nitrate, ferrous sulfate, and ferrous sulfate. The manganese salt may include one or more of manganese nitrate, manganese chloride, manganese sulfate, manganese acetate and manganese oxalate, optionally, one or more of manganese nitrate and manganese sulfate. The salt containing M element can be one or more of nitrates, chlorates, sulfates, oxalates, and acetates containing M element, optionally, one or more of nitrates and sulfates containing M element. The solvent can include one or more of deionized water, methanol, ethanol, acetone, isopropyl alcohol, and n-hexyl alcohol, optionally, deionized water.

Reactants having different concentrations in the reaction solution, on the one hand, enables the reactants to have different dissociation rates, thereby affecting the reaction rate, on the other hand, directly affects the reaction rate, thereby affecting the chemical composition and structure of the transitional metal source, and finally affecting the chemical composition and structure of the positive electrode active material.

In some preferred embodiments, in the step S10, the total concentration of metal ions in the mixed solution is preferable to be from 0.1 mol/L to 10 mol/L, more preferable, from 0.5 mol/L to 5 mol/L.

In the reaction system, the type and concentration of precipitant affect its reaction rate with metal ions, and the type and concentration of complexing agent significantly affect the crystal nucleation and growth of the transitional metal source, which both affect the chemical composition and structure of the transitional metal source.

In some preferred embodiments, in the step S20, the precipitant can include one or more of sodium hydroxide, potassium hydroxide, sodium bicarbonate, potassium bicarbonate, sodium carbonate, and potassium carbonate, optionally, one or more of sodium carbonate and sodium hydroxide. The complexing agent can include one or more of ammonia, ammonium carbonate, ammonium bicarbonate, urea, hexamethylene tetramine, ethylenediamine tetraacetic acid, citric acid and ascorbic acid, optionally, ammonia.

The pH value of the reaction system affects the precipitation rate of every metal ion, thereby directly affecting the crystal nucleation and growth rate of the transitional metal source, further affecting the chemical composition and structure of the transitional metal source, and finally affecting the chemical composition and structure of the positive electrode active material. In order to achieve the positive electrode active material in this application, in the step S20, optionally, the pH value of the reaction solution is controlled to be from 6 to 13, more optionally, the pH value of the reaction solution is controlled to be from 10 to 12. When necessary, the pH value of the reaction solution can be adjusted by adjusting the type and content of precipitant and/or complexing agent.

In some examples, the step S20 can include:

S21. providing a solution of precipitant and a solution of complexing agent;

S22. adding the solution of precipitant and the solution of complexing agent to the mixed solution to obtain a reaction solution, and adjusting pH value of the reaction solution to a preset range.

In some examples, the step S21 comprises dispersing a precipitant into a solvent to obtain a solution of precipitant.

The solvent used for the solution of precipitant can be one or more of deionized water, methyl alcohol, ethyl alcohol, acetone, isopropyl alcohol, and n-hexyl alcohol.

In some examples, the concentration of precipitant in the solution of precipitant is preferable to be from 0.5 mol/L to 15 mol/L, more preferable, from 2 mol/L to 10 mol/L.

In some examples, the step S21 comprising dispersing a complexing agent into a solvent to obtain a solution of complexing agent.

The solvent used for the solution of complexing agent can be one or more of deionized water, methyl alcohol, ethyl alcohol, acetone, isopropyl alcohol, and n-hexyl alcohol.

In some examples, the concentration of complexing agent in the solution of complexing agent is preferable to be from 0.1 mol/L to 15 mol/L, more preferable, from 0.5 mol/L to 10 mol/L.

In addition, the temperature of the reaction system directly affects the chemical reaction rate and the reaction yield and the reaction time affects the growth process of reaction products, thereby affecting the chemical composition and structure of the reaction products. In some embodiments, optionally, in the step S30, the reaction temperature is from 25° C. to 70° C., more preferable, from 40° C. to 65° C., and particularly preferable, from 50° C. to 60° C. The reaction time is preferable to be from 10 h to 60 h, more preferable, from 20 h to 30 h.

The stirring rate during the reaction affects the mixing uniformity of materials so that it has an important influence on the effect of complexation and precipitation, and further affects the structure of the transitional metal source. In some embodiments, optionally, in the step S30, the stirring rate is from 200 rpm to 1600 rpm, for example, from 300 rpm to 1000 rpm, or from 500 rpm to 900 rpm. The abbreviation “rpm”, refers to round per minute, which characterizes the number of revolution of the stirring equipment per minute.

In some embodiments, the drying temperature in the step S30 is preferable to be from 80° C. to 120° C. The drying time in the step S30 is preferable to be from 2 h to 48 h.

In the step S40, the temperature and time of sintering affect the specific surface area, particle size, shape, and crystal structure of the reaction products. In some embodiments, optionally, in the step S40, the temperature of sintering is from 700° C. to 1100° C., more optionally, from 850° C. to 950° C. The time of sintering is preferable to be from 4 h to 30 h, more preferable, from 8 h to 20 h.

In some embodiments, in the step S40, the sodium source can be one or more of sodium carbonate, sodium hydroxide, and sodium nitrate.

In the step S40, the sintering can be carried out in an air or oxygen atmosphere.

In the steps S30 and S40, the detergent used for washing and the number of washing are not specially restricted and can be selected according to the actual demand as long as the residual ions on the surface of products are removed. For example, deionized water can be used as a detergent.

During the preparation process of positive electrode active material of the present application, by comprehensively controlling the type and content of reactants, pH value, the type and concentration of precipitant, the type and concentration of complexing agent, reaction temperature, stirring rate, reaction time, and sintering temperature and time enables the positive electrode active material to have a specific chemical composition and structure stated in this application, which can greatly improve the electrochemical performance of the positive electrode active material. By adopting the positive active material may improve the specific capacity, cycle performance, and safety performance of the sodium ion battery.

### Positive Electrode Plate

This application also provides a positive electrode plate comprising a positive electrode current collector and a positive electrode active material layer disposed on the positive electrode current collector. For example, the positive electrode current collector has two opposite surfaces and the positive electrode active material layer is laminated on either or both of the two surfaces of the positive electrode current collector.

In some embodiments, a metal foil, a carbon-coated metal foil, or a porous metal sheet can be adopted for the positive electrode current collector, optionally, an aluminum foil.

The positive electrode active material layer includes the positive electrode active material in the first aspect of this application. Optionally, the positive electrode active material in the positive electrode active material layer is one or more of Na_{0.88}Cu_{0.24}Fe_{0.29}Mn_{0.47}O₂, Na_{0.71}Cu_{0.22}Fe_{0.30}Mn_{0.48}O₂, Na_{0.88}Cu_{0.22}Fe_{0.28}Mn_{0.47}Mg_{0.03}O₂ and Na_{0.88}Cu_{0.22}Fe_{0.28}Mn_{0.47}Al_{0.03}O₂.

In some examples, the positive electrode active material layer can also include a binder. As an example, the binder can include one or more of styrene-butadiene rubber (SBR), water-based acrylic resin, sodium carboxymethyl cellulose (CMC-Na), polyvinylidene fluoride (PVDF), polytetrafluoroethylene (PTFE), ethylene-vinyl acetate copolymer (EVA) and polyvinyl alcohol (PVA).

In some examples, the positive electrode active material layer can also include a conductive agent. The conductive agent can include one or more of super-conductive carbon, acetylene black, carbon black, ketjen black, carbon dot, carbon nanotubes, graphene, and carbon nanofiber.

The positive electrode plate can be prepared according to the conventional method in this field. Usually, the positive electrode plate is obtained by dispersing the positive electrode active material and optional conductive agent and binder in a solvent (e.g., N-methyl-2-pyrrolidone. NMP for short) to form an uniform positive electrode slurry, coating a positive electrode current collector with the positive electrode slurry and then carrying out the processes of drying and cold pressing.

As the positive electrode plate of this application adopts the positive electrode active material in the first aspect of this application, it has a relatively high comprehensive electrochemical performance and safety performance.

### Sodium ion Battery

In a third aspect, this application provides a sodium ion battery including the said positive electrode plate containing one or more positive electrode active materials of this application.

Sodium ion battery also includes a negative electrode plate, a separator, and an electrolyte.

In some embodiments, the negative electrode plate can be a metallic sodium sheet.

In some embodiments, the negative electrode plate can include a negative electrode current collector and a negative electrode active material layer disposed on the negative electrode current collector. For example, the negative electrode current collector has two opposite surfaces and the negative electrode active material layer is laminated on either or both of the two surfaces of the negative electrode current collector.

In some embodiments, a metal foil, a carbon-coated metal foil, a porous metal sheet, and other materials can be adopted for the negative electrode current collector, optionally, a copper foil.

The negative electrode active material layer includes a negative electrode active material, which can be the known negative electrode active material in this field. As an example, the negative electrode active material can include, but is not limited to, one or more of natural graphite, artificial graphite, mesocarbon microbeads (MCMB), hard carbon, and soft carbon.

In some embodiments, the negative electrode active material layer can also include a conductive agent, which can be the known conductive agent used for battery negative electrode in this field. As an example, the conductive agent can include, but is not limited to, one or more of super-conductive carbon, acetylene black, carbon black, ketjen black, carbon dot, carbon nanotubes, graphene, and carbon nanofiber.

In some embodiments, the negative electrode active material layer can also include a binder, which can be the known binder used for battery negative electrode in this field. As an example, the binder can include, but is not limited to, one or more of styrene-butadiene rubber (SBR), water-based acrylic resin, and sodium carboxymethyl cellulose (CMC-Na).

In some examples, the negative electrode active material layer can also include a thickening agent, which can be the known thickening agent used for battery negative electrode in this field. As an example, the thickening agent can be or include sodium carboxymethyl cellulose (CMC-Na).

The said negative electrode plate can be prepared according to the conventional method in this field. Usually, the negative electrode plate is obtained by dispersing the negative electrode active material and optional conductive agent, binder and thickener in a solvent in which the solvent may be deionized water to form an uniform negative electrode slurry, coating a negative electrode current collector with the negative electrode slurry and then carrying out the processes of drying and cold pressing.

There is no special restriction on the separator. Any known porous separator with electrochemical stability and chemical stability can be selected, for example, glass fiber, non-woven fabrics, polyethylene, polypropylene, polyvinylidene dichloride, and their multi-layer composite film.

In some embodiments, the electrolyte can include an organic solvent and an electrolyte sodium salt. As an example, the organic solvent can include one or more of ethylene carbonate (EC), propylene carbonate (PC), ethyl methyl carbonate (EMC) and diethyl carbonate (DEC). The electrolyte sodium salt can include one or more of NaPF₆, NaClO₄, NaBCl₄, NaSO₃CF₃, and Na (CH₃) C₆H₄SO₃.

As the sodium ion battery of this application adopts the positive electrode active material in the first aspect of this application, it has a relatively high comprehensive electrochemical performance, including relatively high first-cycle specific discharge capacity and energy density, as well as relatively high cycle performance and safety performance.

The present application does not have particular limitation to the shape of the sodium ion battery. The sodium ion battery may be cylindrical, square, or in other arbitrary shape. FIG. 1 shows a sodium ion battery 5 with a square structure as an example.

In some embodiments, the sodium ion battery may include an outer package for packaging the positive electrode plate, the negative electrode plate, and the electrolyte.

In some embodiments, the outer package of the sodium ion battery may be a soft bag, such as a pocket type soft bag. The material of the soft bag may be plastic, for example, it may include one or more of polypropylene (PP), polybutylene terephthalate (PBT), polybutylene succinate (PBS), and the like. The outer package of the sodium ion battery may also be a hard case, such as a hard plastic case, an aluminum case, a steel case, and the like.

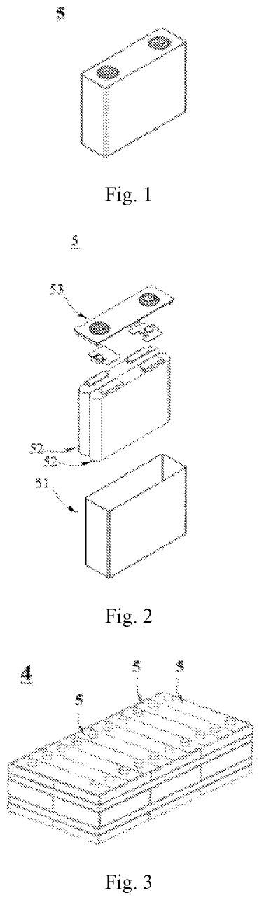

In some embodiments, referring to FIG. 2, the outer package may include a shell 51 and a cover plate 53. The shell 51 may include a bottom plate and side plates connected to the bottom plate, and the bottom plate and the side plates enclose a receiving cavity. The shell 51 has an opening communicated with the receiving cavity, and the cover plate 53 can cover the opening to close the receiving cavity.

The positive electrode plate, the negative electrode plate, and the separator may form an electrode assembly 52 by stacking or winding. The electrode assembly 52 is packaged in the receiving cavity. The electrolyte may adopt electrolyte liquid, and the electrolyte liquid infiltrates the electrode assembly 52.

The sodium ion battery 5 includes one or more electrode assemblies 52, which can be adjusted according to requirements.

In some embodiments, the sodium ion batteries may be assembled into a battery module, the battery module may include a plurality of secondary batteries, and the specific number can be adjusted according to the application and capacity of the battery module.

FIG. 3 shows a battery module 4 as an example. Referring to FIG. 3, in the battery module 4, the plurality of sodium ion batteries 5 may be arranged sequentially in a length direction of the battery module 4. Of course, they may also be arranged in any other way. Further, a plurality of sodium ion batteries 5 may be fixed by fasteners.

Optionally, the battery module 4 may further include a housing having a receiving space, and a plurality of secondary batteries 5 are received in the receiving space.

In some embodiments, the above-mentioned battery module may also be assembled into a battery pack, and the number of battery modules included in the battery pack can be adjusted according to the application and capacity of the battery pack.

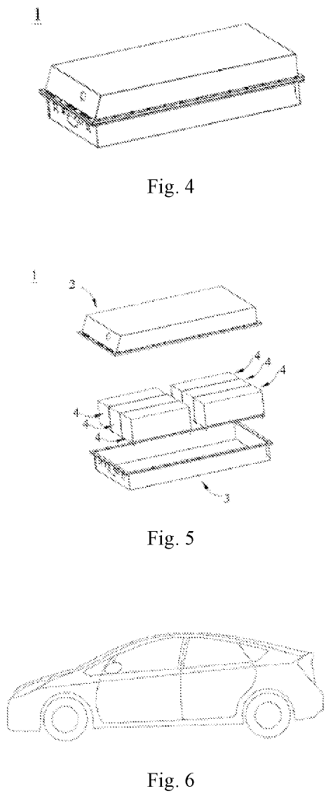

FIGS. 4 and 5 show a battery pack 1 as an example. Referring to FIGS. 4 and 5, the battery pack 1 may include a battery case and a plurality of battery modules 4 disposed in the battery case. The battery case includes an upper case body 2 and a lower case body 3. The upper case body 2 can cover the lower case body 3 to form a closed space for receiving the battery modules 4. A plurality of battery modules 4 can be arranged in the battery cabinet in any manner.

### Apparatus

The fourth aspect of the present application provides an apparatus, the apparatus including the sodium ion battery according to the third aspect of the present application. The sodium ion battery can be used as a power source of the apparatus, or as an energy storage unit of the apparatus. The apparatus may be, but is not limited to, a mobile device (e.g., a mobile phone, a notebook computer, and the like), an electric vehicle (e.g., a pure electric vehicle, a hybrid electric vehicle, a plug-in hybrid electric vehicle, an electric bicycle, an electric scooter, an electric golf vehicle, an electric truck and the like), an electric train, a ship, a satellite, an energy storage system, and the like.

The apparatus may select the sodium ion battery, the battery module, or the battery pack according to its usage requirements.

FIG. 6 shows an apparatus as an example. The apparatus is a pure electric vehicle, a hybrid electric vehicle, or a plug-in hybrid electric vehicle. In order to meet the requirements of the apparatus for high power and high energy density of the sodium ion battery, a battery pack or a battery module may be used.

As another example, the apparatus may be a mobile phone, a tablet computer, a notebook computer, and the like. The apparatus is generally required to be thin and light, and the sodium ion battery can be used as a power source.

### EXAMPLES

The following examples more specifically describe the content disclosed in the present application, and these examples are only used for explanatory description, because various modifications and changes within the scope of the present disclosure are obvious to those skilled in the art. Unless otherwise stated, all parts, percentages, and ratios described in the following examples are based on weight, all reagents used in the examples are commercially available or synthesized according to conventional methods and can be directly used without further treatment, and all instruments used in the examples are commercially available.

### Example 1

### Preparation of Positive Electrode Active Material

S10. Copper sulfate, ferrous sulfate and manganese sulfate were dissolved in a deionized water in a stoichiometric ratio under the protection of inert atmosphere to prepare a mixed solution, in which the total concentration of metal ions was 1.5 mol/L.

S21. Sodium hydroxide as a precipitant was dispersed in a deionized water to prepare a solution of precipitant, in which the concentration of sodium hydroxide was 4 mol/L. An ammonia with a concentration of 1 mol/L was used as a solution of complexing agent.

S22. The solution of precipitant and the solution of complexing agent were added to the above mixed solution to obtain a reaction solution, and the pH value of the reaction solution was controlled to 11.2.

S30. The reaction solution was carried out reaction for 30 h at a temperature of 60° C. with a stirring rate of 800 rpm, the resulting coprecipitation product was isolated and collected. After that, the product was washed several times with an appropriate amount of deionized water, and was dried at 100° C. in a vacuum drying oven to obtain a transitional metal source Cu_{0.24}Fe_{0.29}Mn_{0.47}](OH)₂.

S40. Sodium carbonate and the transitional metal source were mixed uniformly in a molar ratio of 0.92:1 to obtain a mixture, and the mixture was sintered at a temperature of 960° C. under an air atmosphere for 15 h. After that, the sintered product was cooled to room temperature, and then washed several times with an appropriate amount of deionized water followed by drying to obtain the positive electrode active material.

### Preparation of Button Battery

1) Preparation of Positive Electrode Plate

The positive electrode active material prepared above, conductive black Super P, and PVDF as a binder at a weight ratio of 90:5:5 were mixed in an appropriate amount of N-methyl pyrrolidone (NMP) to form a uniform positive electrode slurry; and the positive electrode slurry was coated on an aluminum foil as a positive electrode current collector. After drying, it was stamped into a wafer with a diameter of 14mm.

2) Preparation of Negative Electrode Plate

A metallic sodium sheet was stamped into a wafer with a diameter of 14mm.

3) Fiberglass Film was Used as a Separator.

4) Preparation of Electrolyte

Ethylene carbonate (EC) and propylene carbonate (PC) were mixed in an equal volume to get an organic solvent, and sodium perchlorate NaClO₄ was dissolved in the said organic solvent to obtain the electrolyte, in which the concentration of NaClO₄ was 1 mol/L.

5) The said positive electrode plate, separator, and negative electrode plate were stacked in order in which the said electrolyte was added and which was sealed to obtain the button battery.

### Examples 2 to 17 and Comparative Example 1

Examples 2 to 17 and Comparative Example 1 are similar to example 1 with the exception that the reaction parameters for the preparation process of positive electrode active material were adjusted. Refer to Table 1 below for the specific parameters.

### Test Section

Test of Capacity Elaboration and Cycle Performance

At a temperature of 25° C. and under the normal pressure of 0.1 MPa, the sodium ion batteries prepared by the examples and comparative examples were charged at a constant current to 4.05V at a rate of 0.1C, where the charge capacity at this time was recorded as the first-cycle charge capacity of sodium ion battery; after set standing for 5 min, they were discharged at a constant current to 2.5V at a rate of 0.1C, and then set standing for 5 min. This was a charging/discharging cycle. At this time, the discharge capacity was recorded as a first-cycle discharge specific capacity of the sodium-ion battery, which was the initial capacity of the sodium-ion battery. The sodium ion battery was subjected to the above charging/discharging cycle test for 100 cycles, and the specific discharge capacity at the 100^{th} cycle was detected.

The capacity retention rate of the sodium ion battery for 100 cycles (%)=the specific discharge capacity at the 100^{th} cycle/the specific discharge capacity at the first cycle×100%.

The test results of Examples 1 to 17 (Ex. 1-17) and Comparative Examples 1 to 2 (CEx. 1-2) were shown in Table 2 below.

| | | | | | Total | | Type and | | | |
|---|---|---|---|---|---|---|---|---|---|---|
| | | | | | concentration | Type and | concentration of | | Reaction | Sintering |
| | Copper | | | | of metal ions | concentration of | complexing | | temperature and | temperature and |
| | salt | Iron salt | Mg salt | M salt | mol/L | precipitant | agent | pH | time | time |
| Ex. 1 | Copper | Ferrous | Manganese | / | 1.5 | 4 mol/L | 1 mol/L | 11.2 | 60° C. | 960° C. |
| | sulfate | sulfate | sulfate | | | Sodium hydroxide | Ammonia | | 30 h | 15 h |
| Ex. 2 | Copper | Ferrous | Manganese | / | 1.5 | 4 mol/L | 1 mol/L | 11.2 | 60° C. | 940° C. |
| | sulfate | sulfate | sulfate | | | Sodium hydroxide | Ammonia | | 30 h | 15 h |
| Ex. 3 | Copper | Ferrous | Manganese | / | 1.5 | 4 mol/L | 1 mol/L | 11.2 | 60° C. | 920° C. |
| | sulfate | sulfate | sulfate | | | Sodium hydroxide | Ammonia | | 30 h | 15 h |
| Ex. 4 | Copper | Ferrous | Manganese | / | 1.5 | 4 mol/L | 1 mol/L | 11.2 | 50° C. | 920° C. |
| | sulfate | sulfate | sulfate | | | Sodium hydroxide | Ammonia | | 30 h | 15 h |
| Ex. 5 | Copper | Ferrous | Manganese | / | 1.5 | 4 mol/L | 1 mol/L | 11.2 | 50° C. | 900° C. |
| | sulfate | sulfate | sulfate | | | Sodium hydroxide | Ammonia | | 30 h | 15 h |
| Ex. 6 | Copper | Ferrous | Manganese | / | 1.5 | 4 mol/L | 1 mol/L | 11.2 | 50° C. | 880° C. |
| | sulfate | sulfate | sulfate | | | Sodium hydroxide | Ammonia | | 30 h | 15 h |
| Ex. 7 | Copper | Ferrous | Manganese | / | 1.5 | 4 mol/L | 1 mol/L | 11.2 | 50° C. | 880° C. |
| | sulfate | sulfate | sulfate | | | Sodium hydroxide | Ammonia | | 20 h | 12 h |
| Ex. 8 | Copper | Ferrous | Manganese | / | 1.5 | 4 mol/L | 1 mol/L | 11.2 | 50° C. | 860° C. |
| | sulfate | sulfate | sulfate | | | Sodium hydroxide | Ammonia | | 20 h | 12 h |
| Ex. 9 | Copper | Ferrous | Manganese | / | 1.5 | 4 mol/L | 1 mol/L | 11.2 | 50° C. | 820° C. |
| | sulfate | sulfate | sulfate | | | Sodium hydroxide | Ammonia | | 20 h | 12 h |
| Ex. 10 | Copper | Ferrous | Manganese | / | 1.5 | 4 mol/L | 1 mol/L | 11.2 | 50° C. | 800° C. |
| | sulfate | sulfate | sulfate | | | Sodium hydroxide | Ammonia | | 20 h | 12 h |
| Ex. 11 | Copper | Ferrous | Manganese | / | 0.5 | 2 mol/L | 0.5 mol/L | 11.0 | 50° C. | 900° C. |
| | nitrate | nitrate | nitrate | | | Sodium hydroxide | Ammonium | | 30 h | 15 h |
| | | | | | | | Carbonate | | | |
| Ex. 12 | Copper | Ferrous | Manganese | / | 1 | 2 mol/L | 1 mol/L | 11.0 | 50° C. | 900° C. |
| | nitrate | nitrate | nitrate | | | Sodium hydroxide | Ammonium | | 30 h | 15 h |
| | | | | | | | Bicarbonate | | | |
| Ex. 13 | Copper | Ferrous | Manganese | / | 2 | 6 mol/L | 1 mol/L | 11.4 | 50° C. | 900° C. |
| | nitrate | nitrate | nitrate | | | Sodium hydroxide | Urea | | 30 h | 15 h |
| Ex. 14 | Copper | Ferrous | Manganese | / | 3 | 8 mol/L | 2 mol/L | 11.4 | 50° C. | 900° C. |
| | nitrate | nitrate | nitrate | | | Sodium hydroxide | Ammonia | | 30 h | 15 h |
| Ex. 15 | Copper | Ferrous | Manganese | / | 1 | 2 mol/L | 1 mol/L | 11.0 | 50° C. | 900° C. |
| | nitrate | nitrate | nitrate | | | Sodium hydroxide | Ammonia | | 30 h | 15 h |
| Ex. 16 | Copper | Ferrous | Manganese | Magnesium | 1.5 | 4 mol/L | 1 mol/L | 11.2 | 50° C. | 900° C. |
| | sulfate | sulfate | sulfate | Sulfate | | Sodium hydroxide | Ammonia | | 30 h | 15 h |
| Ex. 17 | Copper | Ferrous | Manganese | Aluminum | 1.5 | 4 mol/L | 1 mol/L | 11.2 | 50° C. | 900° C. |
| | sulfate | sulfate | sulfate | sulfate | | Sodium hydroxide | Ammonia | | 30 h | 15 h |
| CEx. 1 | Copper | Ferrous | Manganese | / | 4 | 10 mol/L | 8 mol/L | 11.8 | 50° C. | 800° C |
| | sulfate | sulfate | sulfate | | | Sodium hydroxide | Ammonia | | 30 h | 15 h |
| CEx. 2 | Copper | Ferrous | Manganese | / | 4 | 10 mol/L | 8 mol/L | 11.5 | 50° C. | 900° C. |
| | nitrate | nitrate | nitrate | | | Sodium hydroxide | Ammonia | | 30 h | 13 h |

TABLE 2

| | | | | | First-cycle | capacity retention |
|---|---|---|---|---|---|---|
| | | | Specific | | specific | rate of the sodium |
| | | Water | surface | | discharge | ion battery for 100 |
| | Positive electrode active | content | area | Dᵥ 50 | capacity | cycles |
| | material | ppm | m²/g | μm | mAh/g | % |
| Example 1 | Na_{0.88}Cu_{0.24}Fe_{0.29}Mn_{0.47}O₂ | 10 | 5 | 9 | 107 | 96 |
| Example 2 | Na_{0.88}Cu_{0.24}Fe_{0.29}Mn_{0.47}O₂ | 50 | 5 | 9 | 106 | 96 |
| Example 3 | Na_{0.88}Cu_{0.24}Fe_{0.29}Mn_{0.47}O₂ | 300 | 5 | 8 | 104 | 95 |
| Example 4 | Na_{0.88}Cu_{0.24}Fe_{0.29}Mn_{0.47}O₂ | 600 | 5 | 7 | 104 | 94 |
| Example 5 | Na_{0.88}Cu_{0.24}Fe_{0.29}Mn_{0.47}O₂ | 800 | 5 | 7 | 103 | 94 |
| Example 6 | Na_{0.88}Cu_{0.24}Fe_{0.29}Mn_{0.47}O₂ | 1000 | 5 | 7 | 103 | 92 |
| Example 7 | Na_{0.88}Cu_{0.24}Fe_{0.29}Mn_{0.47}O₂ | 1500 | 5 | 5 | 103 | 91 |
| Example 8 | Na_{0.88}Cu_{0.24}Fe_{0.29}Mn_{0.47}O₂ | 2000 | 5 | 5 | 100 | 91 |
| Example 9 | Na_{0.88}Cu_{0.24}Fe_{0.29}Mn_{0.47}O₂ | 4000 | 5 | 4 | 98 | 90 |
| Example 10 | Na_{0.88}Cu_{0.24}Fe_{0.29}Mn_{0.47}O₂ | 6000 | 5 | 4 | 97 | 90 |
| Example 11 | Na_{0.88}Cu_{0.24}Fe_{0.29}Mn_{0.47}O₂ | 800 | 0.01 | 30 | 95 | 88 |
| Example 12 | Na_{0.88}Cu_{0.24}Fe_{0.29}Mn_{0.47}O₂ | 800 | 0.5 | 22 | 97 | 89 |
| Example 13 | Na_{0.88}Cu_{0.24}Fe_{0.29}Mn_{0.47}O₂ | 800 | 15 | 1 | 96 | 90 |
| Example 14 | Na_{0.88}Cu_{0.24}Fe_{0.29}Mn_{0.47}O₂ | 800 | 25 | 0.5 | 93 | 87 |
| Example 15 | Na_{0.71}Cu_{0.22}Fe_{0.30}Mn_{0.48}O₂ | 800 | 5 | 6 | 98 | 93 |
| Example 16 | Na_{0.88}Cu_{0.22}Fe_{0.28}Mn_{0.47}Mg_{0.03}O₂ | 800 | 5 | 8 | 102 | 96 |
| Example 17 | Na_{0.88}Cu_{0.22}Fe_{0.28}Mn_{0.47}Al_{0.03}O₂ | 800 | 5 | 10 | 101 | 95 |
| Comparative | Na_{0.88}Cu_{0.24}Fe_{0.29}Mn_{0.47}O₂ | 7000 | 30 | 0.3 | 65 | 51 |
| Example 1 | | | | | | |
| Comparative | Na_{0.71}Cu_{0.22}Fe_{0.30}Mn_{0.48}O₂ | 8000 | 30 | 0.6 | 61 | 47 |
| Example 2 | | | | | | |

By comparing Examples of 1-17 with Comparative Examples of 1-2, it can be seen that, since the positive electrode active material of Comparative Examples 1 to 2 has a higher water content, the positive electrode active material had a higher reaction activity with the electrolyte and carbon dioxide in the environment, and had more side reactions, and the migration of ions and electrons in the particles was hindered significantly, thereby deteriorating the capacity and cycle performance of the sodium ion battery severely. Nevertheless, the positive electrode active material in Examples 1-17 had a water content of below 6000 ppm, which water content was low, the stability of the positive electrode active material to air and carbon dioxide was high, the oxidation activity of the positive electrode active material to electrolyte was low, and the migration of ions and electrons inside the particles was less hindered, so that the positive electrode active material had higher ion conductivity and conductivity, thereby enabling the sodium ion battery using the positive electrode active material of the present application to have significantly improved capacity elaboration and cycle performance.

Some exemplary embodiments of the present invention are provided as follows.

Embodiment 1. A positive electrode active material, satisfying a chemical formula of

Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m<0.1, h+k+l+m=1, 0≤y<0.2, and the positive electrode active material has a water content of 6000 ppm or less.

Embodiment 2. The positive active material according to Embodiment 1, wherein the positive active material has a water content of 10 ppm to 6000 ppm, preferably from 50 ppm to 2000 ppm.

Embodiment 3. The positive active material according to Embodiment 1 or 2, wherein the positive active material has a specific surface area of from 0.01 m²/g to 25 m²/g, preferably from 0.5 m²/g to 15 m²/g.

Embodiment 4. The positive electrode active material according to any one of Embodiments 1 to 3, wherein the positive electrode active material has an average particle size Dv50 of from 0.5 μm to 30 μm, preferably from 1 μm to 15 μm.

Embodiment 5. The positive electrode active material according to any one of Embodiments 1 to 4, wherein the positive electrode active material has a hexagonal layered crystal structure.

Embodiment 6. The positive electrode active material according to any one of Embodiments 1 to 5, wherein the positive electrode active material comprises a characteristic diffraction peak of (003) crystal plane and a characteristic diffraction peak of (104) crystal plane, and the characteristic diffraction peak of (003) crystal plane has a full width at half maxima of from 0.01° to 0.5°, and the characteristic diffraction peak of (104) crystal plane has a full width at half maxima of from 0.01° to 0.5°.

Embodiment 7. The positive electrode active material according to any one of Embodiments 1-6, wherein the positive electrode active material has a powder resistivity of from 10 μ·cm to 90 kΩ·cm at a pressure of 12 MPa, preferably from 20 Ω·cm to 5 kΩ·cm.

Embodiment 8. The positive electrode active material according to any one of Embodiments 1-7, wherein
the positive electrode active material has a tap density of from 1 g/cm³ to 3.5 g/cm³, preferably from 1.5 g/cm³ to 3.0 g/cm³; and/or,
the positive electrode active material has a compaction density of from 2.5 g/cm³ to 5.0 g/cm³ at a pressure of 8 tons, preferably from 3.5 g/cm³ to 4.5 g/cm³.

Embodiment 9. The positive electrode active material according to any one of Embodiments 1-8, wherein the positive electrode active material has a shape comprising one or more of sphere, globoid, and polygon flake.

Embodiment 10. A method for preparing a positive electrode active material, comprising the following steps:
providing a mixed solution, the mixed solution comprising copper salts, iron salts and manganese salts, and the mixed solution comprising salts containing an M element in an amount of ≥0;
adding a precipitant and a complexing agent into the mixed solution, and then subjecting it to coprecipitation to obtain a precursor; and
mixing the precursor and a sodium source to obtain a mixture and sintering the mixture to obtain the positive electrode active material,
wherein the positive electrode active material satisfies a chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m<0.1, h+k+l+m=1, 0≤y<0.2, and the positive electrode active material has a water content of 6000 ppm or less.

Embodiment 11. A sodium-ion battery, comprising a positive electrode plate, wherein the positive electrode plate comprises the positive electrode active material according to any one of Embodiments 1-9.

Embodiment 12. An apparatus, comprising the sodium-ion battery according to Embodiment 11.

Described above are merely specific embodiments of the present application, but the protection scope of the present application is not limited to this. Any skilled person who is familiar with this art could readily conceive of various equivalent modifications or substitutions within the disclosed technical scope of the present application, and these modifications or substitutions shall fall within the protection scope of the present application. Therefore, the protection scope of the present application shall be subject to the protection scope of the claims.

What is claimed is:

1. A positive electrode active material, satisfying a chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h<0.24, 0≤k≤0.32, 0<l≤0.68, 0≤m<0.1, h+k+l+m=1, 0≤y<0.2, and the positive electrode active material has a water content of 6000 ppm or less.

2. The positive active material according to claim 1, wherein the positive active material has a water content of 10 ppm to 6000 ppm, optionally from 50 ppm to 2000 ppm.

3. The positive active material according to claim 1, wherein the positive active material has a specific surface area of from 0.01 m²/g to 25 m²/g, optionally from 0.5 m²/g to 15 m²/g.

4. The positive electrode active material according to claim 1, wherein the positive electrode active material has an average particle size Dv50 of from 0.5 μm to 30 μm, optionally from 1 μm to 15 μm.

5. The positive electrode active material according to claim 1, wherein the positive electrode active material has a hexagonal layered crystal structure.

6. The positive electrode active material according to claim 1, wherein the positive electrode active material comprises a characteristic diffraction peak of (003) crystal plane and a characteristic diffraction peak of (104) crystal plane, and the characteristic diffraction peak of (003) crystal plane has a full width at half maxima of from 0.01° to 0.5°, and the characteristic diffraction peak of (104) crystal plane has a full width at half maxima of from 0.01° to 0.5°.

7. The positive electrode active material according to claim 1, wherein the positive electrode active material has a powder resistivity of from 10 Ω·cm to 90 kΩ·cm at a pressure of 12 MPa, optionally from 20 Ω·cm to 5 kΩ·cm.

8. The positive electrode active material according to claim 1, wherein
the positive electrode active material has a tap density of from 1 g/cm³ to 3.5 g/cm³, optionally from 1.5 g/cm³ to 3.0 g/cm³; and/or,
the positive electrode active material has a compaction density of from 2.5 g/cm³ to 5.0 g/cm³ at a pressure of 8 tons, optionally from 3.5 g/cm³ to 4.5 g/cm³.

9. The positive electrode active material according to claim 1, wherein the positive electrode active material has a shape comprising one or more of sphere, globoid, and polygon flake.

10. A method for preparing a positive electrode active material, comprising the following steps:
providing a mixed solution, the mixed solution comprising copper salts, iron salts and manganese salts, and the mixed solution comprising salts containing an M element in an amount of ≥0;
adding a precipitant and a complexing agent into the mixed solution, and then subjecting it to coprecipitation to obtain a precursor; and
mixing the precursor and a sodium source to obtain a mixture and sintering the mixture to obtain the positive electrode active material,
wherein the positive electrode active material satisfies a chemical formula of Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m<0.1, h+k+l+m=1, 0≤y<0.2, and the positive electrode active material has a water content of 6000 ppm or less.

11. A sodium-ion battery, comprising a positive electrode plate, wherein the positive electrode plate comprises a positive electrode active material, satisfying a chemical formula of
Na₁₋ₓCuₕFeₖMnₗMₘO_{2-y} wherein M is one or more selected from Li, Be, B, Mg, Al, K, Ca, Ti, Co, Ni, Zn, Ga, Sr, Y, Nb, Mo, In, Sn, and Ba, 0<x≤0.33, 0<h≤0.24, 0≤k≤0.32, 0<l≤0.68, 0≤m<0.1, h+k+l+m=1, 0≤y<0.2, and the positive electrode active material has a water content of 6000 ppm or less.

12. The sodium-ion battery according to claim 11, wherein the positive active material has a water content of 10 ppm to 6000 ppm, optionally from 50 ppm to 2000 ppm.

13. The sodium-ion battery according to claim 11, wherein the positive active material has a specific surface area of from 0.01 m²/g to 25 m²/g, optionally from 0.5 m²/g to 15 m²/g.

14. The sodium-ion battery according to claim 11, wherein the positive electrode active material has an average particle size Dv50 of from 0.5 μm to 30 μm, optionally from 1 μm to 15 μm.

15. The sodium-ion battery according to claim 11, wherein the positive electrode active material has a hexagonal layered crystal structure.

16. The sodium-ion battery according to claim 11, wherein the positive electrode active material comprises a characteristic diffraction peak of (003) crystal plane and a characteristic diffraction peak of (104) crystal plane, and the characteristic diffraction peak of (003) crystal plane has a full width at half maxima of from 0.01° to 0.5°, and the characteristic diffraction peak of (104) crystal plane has a full width at half maxima of from 0.01° to 0.5°.

17. The sodium-ion battery according to claim 11, wherein the positive electrode active material has a powder resistivity of from 10 Ω·cm to 90 kΩ·cm at a pressure of 12 MPa, optionally from 20 Ω·cm to 5 kΩ·cm.

18. The sodium-ion battery according to claim 11, wherein
the positive electrode active material has a tap density of from 1 g/cm³ to 3.5 g/cm³, optionally from 1.5 g/cm³ to 3.0 g/cm³; and/or,
the positive electrode active material has a compaction density of from 2.5 g/cm³ to 5.0 g/cm³ at a pressure of 8 tons, optionally from 3.5 g/cm³ to 4.5 g/cm³

19. The sodium-ion battery according to claim 11, wherein the positive electrode active material has a shape comprising one or more of sphere, globoid, and polygon flake.
